(19) United States
(12) Patent Application Publication
(10) Pub. No.: US 2008/0268193 A1
(43) Pub. Date: Oct. 30, 2008

(54) Aqueous media disposable transport and containment material

(76) Inventors: Michelle Cherry, Encino, CA (US); Rob Cherry, Encino, CA (US); Bill Bustamante, Moorpark, CA (US); Thomas Eversole, Los Angeles, CA (US)

Correspondence Address: Donald W. Meeker, 924 East Ocean Front #E, Newport Beach, CA, 92661, US

(21) Appl. No.: 11/796,302

(22) Filed: Apr. 27, 2007

(51) Int. Cl. B32B 27/00

(52) U.S. Cl. 428/36.6

(57) ABSTRACT

A waste containment composite material has a low strength water impermeable barrier layer, a high strength water sensitive layer, and a printed polymer reinforcement pattern applied to the water sensitive layer as a mechanical support layer. Examples of barrier layers include wax, polylactic acid, and other polymers. Examples of water sensitive layers include polyvinyl alcohol. The printed pattern of low permeability polymer support network is applied during the blowing process of the dual layer material.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to flushable materials and particularly to a biological or other material waste container composed of a latently dispersible barrier composite material including an exposed low strength barrier component, an internal high strength water sensitive layer, and a printed polymer reinforcement pattern applied as a mechanical support layer; when exposed to aqueous conditions on the barrier side, the barrier prevents it from passing through to the other layers and when exposed to aqueous conditions on the opposite side, the composite readily disperses and may be disposed of by flushing in a sewer hook up toilet, septic tank or portable chemical type disposal or storage device, for example.

2. Description of Related Art Including Information Disclosed Under 37 CFR 1.97 and 1.98

For numerous applications it is desired to provide a container and/or to temporarily prevent passage of aqueous waste or other aqueous materials and at some later time dispose of the barrier material in a clean and environmentally friendly, aqueous medium containing manner. To be effective, the material used to temporarily prevent passage must provide a barrier to leakage and at the appropriate time desirably break up into components that facilitate suitable disposal while minimizing adverse effects on the environment.

Uses for such latently separable barrier materials include bags or other containers for biological waste, agricultural mats of various kinds, and disposable items like single use beverage containers and the like. Prior attempts to provide such materials have included laminates of film barriers with water sensitive layers of, for example, polyvinyl alcohol.

In use, the barrier contacts the liquid contents and prevents passage until the water sensitive layer is exposed to an aqueous environment. At that point the water sensitive layer dissolves, breaks up or otherwise separates to facilitate disposal. Disposal by flushing in conventional toilets is possible with some of these combinations. Difficulties have been identified with these prior materials because many water sensitive materials like polyvinyl alcohol become dimensionally unstable when exposed to conditions of moderate to high humidity and tend to weaken or stretch.

In use as a container, for example, the material can stretch out of shape and/or weaken to the point of rupture. Attempts to add stability by increasing the barrier film thickness, for example, add unacceptable cost and/or increase the issues to be addressed upon disposal. The thicker films have a greater tendency to remain intact on flushing, for example, and clog toilets or downstream systems.

The prior art fails to solve the problem of environmentally responsible waste disposal in water effectively.

U.S. Pat. No. 3,616,797, issued Nov. 2, 1971 to Champaigne, Jr., provides a flushable wrapper for sanitary napkins, disposable diapers and other absorbent pads. The wrapper comprises a non-woven fiber web bonded by a water-soluble adhesive and overprinted with another binder comprising a spaced pattern if water-insoluble adhesive. The pattern of the latter adhesive is arranged so as to permit the web to be broken up into pieces approximating the size of a postage stamp when the web is soaked in excess water.

U.S. Pat. No. 6,607,226, issued Aug. 19, 2003 to Poncy, concerns a toilet-disposable bag for aqueous disposal. A multiple layered bag is provided that comprises such materials that one surface of the bag degrades when it comes in contact with water, for example polyvinyl alcohol, while the other surface is water resistant, such that the bag can be used to collect moist materials, for example pet excrement, without exposing the bag handler to those moist materials, yet when the everted bag is subjected to an aqueous environment, with the liquid degradable surface exposed to the aqueous environment, all the components of the bag degrade. The bag degrades such that the remaining components of the bag and the contents thereof are easily flushed down the toilet.

U.S. Pat. No. 6,479,105, issued Nov. 12, 2002 to Chang, illustrates a method of making a flushable film having barrier properties comprising a low-molecular weight, amorphous polyalphaolefin layer and a water-sensitive substrate layer. Preferably, the polyalphaolefin comprises either a propylene-ethylene copolymer or an ethylene-butane copolymer. Polyalphaolefin coated water-dispersible films may be advantageously employed in the preparation of a wide variety of products designed to be contacted with aqueous fluids. Although the coated water-dispersible film is particularly suited for personal care products, the coated water-dispersible film may be advantageously employed in the preparation of a wide variety of consumer products other than personal care products. When the entire product is disposed of in water, the water-sensitive layer is wetted and weakens. Since the polyalphaolefin layer is already mechanically weak, hydraulic force from a toilet flow causes the composition to disperse into pieces small enough to flow through the toilet and beyond without clogging the water system. The polyalphaolefin layer may be joined to the water-dispersible substrate by standard methods known to those of ordinary skill in the art. As mentioned, the polyalphaolefin layer itself can provide enough tack to join the water-sensitive substrate layer thereto. Other suitable methods of joining the layers include, but are not limited to, solvent-based coating and hot-melt coating. Suitable solvent-based coating techniques include, but are not limited to, spray coating and ink jet printing. Suitable hot-melt coating techniques include, but are not limited to, slot coating, screen coating, spray coating, swirl coating and gravure coating. Another suitable method includes a transfer coating procedure.

U.S. Patent Application #20040221367, published Nov. 11, 2004 by Darrow, describes a flushable mitt for the sanitary pick up and disposal of dog waste. The flushable mitt includes a mitt body having a top layer and a bottom layer forming an interior space and a mitt opening. The bottom, or palm, side of the mitt is longer than the top side of the mitt and is tapered outward at the opening allowing the user to pull the mitt inside out while holding the waste between the fingertips and thumb. This permits the user to accomplish the task of picking up, containing and disposing of the dog waste without coming in contact with the waste at any time.

U.S. Patent Application #20050004539, published Jan. 6, 2005 by Brown, indicates a drainage bag for receiving bodily waste, such as an ostomy bag, which comprises an outer bag of material soluble in cold water, e.g. polyvinyl alcohol, and an inner bag of material insoluble in water at ambient temperature and body temperature but soluble in organic solvent, e.g. 2-oxepanone polymer (polycaprolactone). When the bag and contents are to be disposed of, appropriate organic solvent (e.g. benzyl alcohol) is applied to the inner bag. The bag can then be placed in a WC bowl and is flushable after about 1-2 minutes.

U.S. Pat. No. 6,783,826, issued Aug. 31, 2004 to Sherrod, shows a flushable commode liner made from a first and a second opposing member defining a top with an opening, a bottom, and a pair of opposing sides. The pair of opposing sides includes a separation distance D, which varies from the top to the bottom, and the distance D is larger at the top than at the bottom. The opposing members can be formed from a latently dispersible barrier composite material including an exposed low strength barrier component, an internal water sensitive layer, and a water permeable, inextensible, water dispersible support layer. When exposed to aqueous conditions on the barrier side, the composite prevents it from passing through to the other layers. When exposed to aqueous conditions on the opposite side, the commode liner readily disperses and may be disposed of by flushing in a toilet, for example. Examples of barrier layers include polylactic acid. Examples of water sensitive layers include polyvinyl alcohol. Examples of support layers include low stretch grades of toilet tissue.

U.S. Pat. No. 6,713,140, issued Mar. 30, 2004 to McCormack, claims a latently dispersible barrier composite material including an exposed low strength barrier component, an internal water sensitive layer, and a water permeable, inextensible, water dispersible support layer. When exposed to aqueous conditions on the barrier side, the composite prevents it from passing through to the other layers. When exposed to aqueous conditions on the opposite side, the composite readily disperses and may be disposed of by flushing in a toilet, for example. Uses are many and include numerous containment applications such as commode liners, containers for bodily and animal wastes, components of personal care products and the like. Examples of barrier layers include polylactic acid. Examples of water sensitive layers include polyvinyl alcohol. Examples of support layers include low stretch grades of toilet tissue.

U.S. Pat. No. 6,664,333, issued Dec. 16, 2003 to Wang, describes cold-water flushable compositions comprising polylactic acid dispersed in polyvinyl alcohol. The selectively cold-water responsive compositions are constructed of combinations of polymers including at least one hydrolytically degradable polymer and at least one cold-water soluble polymer. Additionally, methods of making and using selectively cold-water sensitive compositions are described. In one embodiment, the method comprises combining a polylactide and a cold-water soluble polyvinyl alcohol at a temperature above the melting point of the polymer having the higher melting point, and below the decomposition point of the polymer having the lower decomposition point, to form a homogeneous polymer blend is also provided. The cold-water responsive properties of the compositions of the present invention may be varied include water dispersible, water disintegratable, and water weakenable.

Two patents, U.S. Pat. No. 6,372,850 issued Apr. 16, 2002 and U.S. Pat. No. 6,750,163 issued Jun. 15, 2004 to Wang, disclose melt processable, flushable poly (ethylene oxide) fibers and methods of making melt processable, flushable polymer fibers. The fibers comprise poly(ethylene oxide). Preferably, the poly(ethylene oxide) is modified by grafting polar vinyl monomers, such as poly(ethylene glycol) methacrylate and 2-hydroxyethyl methacrylate, onto poly(ethylene oxide). The modified poly(ethylene oxide) has improved melt processability and can be used to melt process poly(ethylene oxide) fibers of thinner diameters.

Two patents, U.S. Pat. No. 6,075,179 issued Jun. 13, 2000 and U.S. Pat. No. 6,653,523 issued Nov. 25, 2003 to McCormack, indicate a low gauge, multilayer film which may be laminated to other materials such as, for example, fibrous non-woven webs. The multilayer film may include one or more skin layers which in certain configurations comprise no more than about 15 percent of the overall thickness and in other configurations no more than about 10 percent of the overall thickness of the multilayer film. Such films and laminates have a wide variety of uses including, but not limited to, personal care absorbent products, articles of clothing and health care related items such as surgical drapes and gowns.

Five U.S. patents, U.S. Pat. No. 6,500,897 issued Dec. 31, 2002; U.S. Pat. No. 6,552,124 issued Apr. 22, 2003; U.S. Pat. No. 6,579,934 issued Jun. 17, 2003; U.S. Pat. No. 6,890,989 issued May 10, 2005; and U.S. Pat. No. 7,053,151 issued May 30, 2006 to Wang, are for water-responsive biodegradable polymer compositions and a reactive-extrusion process to make the same. A hydrolytically modified, biodegradable polymer and a method of making a hydrolytically modifiable a biodegradable polymer are provided. In a preferred embodiment, the invention is a method of grafting polar groups onto biodegradable polymers and modified biodegradable polymer compositions produced by the method. The polymer compositions are useful as components in flushable and degradable articles. Water-sensitive polymer blends and method of making those polymer blends are also disclosed.

What is needed is a temporary barrier, latently dispersible material that is stable under use conditions but also easily disposable under aqueous conditions as by flushing, for example. The present invention addresses this and similar needs. Uses of the present invention are many and include numerous containment applications such as containers for human bodily and animal wastes, medical device waste containers for human and animal waste, laundry containers for soiled linens, and the like.

### BRIEF SUMMARY OF THE INVENTION

### Definitions:

As used herein unless the context requires a different meaning, the following terms have the meanings set forth below:

As used herein and in the claims, the term “comprising” is inclusive or open-ended and does not exclude additional unrecited elements, compositional components, or method steps.

As used herein the term printed means a pattern printed using conventional or adapted printing techniques developed for “Bag” and Container” printing during fabrication processes”. The basis weight of the printed pattern is usually expressed in ounces of printed film material per square yard (osy) or grams per square meter (gsm) and the fiber diameters useful are usually expressed in microns. (Note that to convert from osy to gsm, multiply osy by 33.91).

As used herein the term printed means applying a pattern on one side of the dual layer film. The printing of the reinforcement pattern on the dual layer material uses conventional web printing methods with air dry (through evaporation VOC) UV cure or other conventional ink curing techniques.

As used herein, the term “flushable” means that an item may be successfully transported through a toilet and through the typical municipal sewerage system piping and pumps without incident (i.e. clogging).

As used herein, the term “water dispersible” refers to structures which when placed in an aqueous environment will, with sufficient time, break apart into smaller pieces. As a result, the structure once dispersed may be more advantageously processable in recycling processes or flushable in, for example, septic and municipal sewage treatment systems. If desired, such structures may be made more water dispersible or the dispersion may be hastened by the use of agitation and/or certain triggering means. The actual amount of time will depend at least in part upon the particular end-use design criteria.

As used herein, the term “biodegradable” means that a material degrades from the action of naturally occurring microorganisms such as bacteria, fungi and algae.

As used herein the term “printed pattern” means a geometric pattern of sufficient coverage area and coverage pattern to render the support-reinforcement to the dual layer polymer sheet for the particular application

As used herein the term “ink” means a polymeric substance which carries a pigment and a reinforcing media to the surface of the membrane as it is printed. The inks may be air cure or UV cure or other means of curing.

As used herein, the term “water sensitive” means a structure or layer that loses integrity in contact with water as by means of breaking up or dissolving, for example, but which maintains effective strength for the desired application.

As used herein, the term “water soluble” means dissolves into water as a homogeneous solution.

As used herein, the term “inextensible” means having machine direction stretch of less than 15%).

An object of the present invention is to provide a temporary barrier, latently dispersible material that is stable under use conditions but also easily disposable under aqueous conditions as by flushing, for example. The present invention addresses this and similar needs. Uses of the present invention are many and include numerous containment applications such as containers for human bodily and animal wastes, medical device waste containers for human and animal waste, laundry containers for soiled linens, and the like.

In brief, the present invention includes a latently dispersible barrier composite using a low strength barrier layer of water insoluble composition combined with a water sensitive, low strength carrier and on the opposing side of the carrier, the barrier side, an inextensible, dispersible printed support network layer. The layers are bonded and provide a barrier to aqueous liquid contact from one side but the combination disperses when contacted by aqueous liquid from the other side.

In use the container or material is exposed to the water bearing material to be contained with its water barrier surface in contact with the water bearing material. The printed reinforcement pattern prevents the water bearing contents from breaching the thin weak barrier layer exposing the water soluble layer to moisture, dissolving the water-soluble layer and thereby causing the failure of the container. In the case of a bag or sack for containing moisture containing materials to be flushed, the bag would be used with the inner non soluble barrier layer exposed to the contents. The latently soluble exterior would be exposed to the moisture only upon immersion during the flushing operation. In use as a container, cover, or the like, convenient and environmentally sensitive disposal may be achieved.

Where all component layers are biodegradable and/or dispersible, disposal is facilitated. For many applications it will be desirable to maintain component layers as light or low basis weight as is compatible with the intended use. In particular, the barrier layer may not be readily dispersible if it is of increased thickness. Cost will provide an incentive to reduce the weight of the component layers, particularly for single use applications. Many such applications will use a barrier layer of polylactic acid having a thickness in the range of from about 0.5 to about 2.0 microns, polyvinyl alcohol film carrier layer having a thickness in the range of from about 10 to about 50 microns, and a printed support-reinforcement layer in the range of from about 10 to about 75 gsm, for example. As a result the composite will desirably have a hydrohead property of at least about 15 mbar, for some applications at least about 25 mbar, for more demanding applications at least about 50 mbar, and in some cases at least about 75 mbar. Bonding of the layers may be by a variety of means that preserve desired properties, including thermal (such as coextrusion or extrusion coating, for example) and adhesive, pattern and smooth bonding means.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a partial perspective broken view of the latently dispersible barrier composite material of the present invention showing an internal high strength water sensitive layer, an exposed low strength barrier component layer, and a printed polymer reinforcement pattern applied as a mechanical support layer to the outer side of the low strength barrier component layer;

FIG. 2 is a cross-sectional view of the latently dispersible barrier composite material of FIG. 1 showing the water sensitive layer, the exposed low strength barrier component layer and the printed polymer reinforcement pattern applied to the barrier component layer.

### DETAILED DESCRIPTION OF THE INVENTION

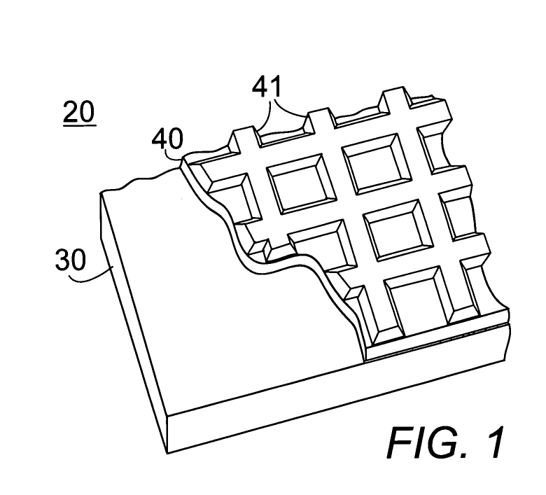

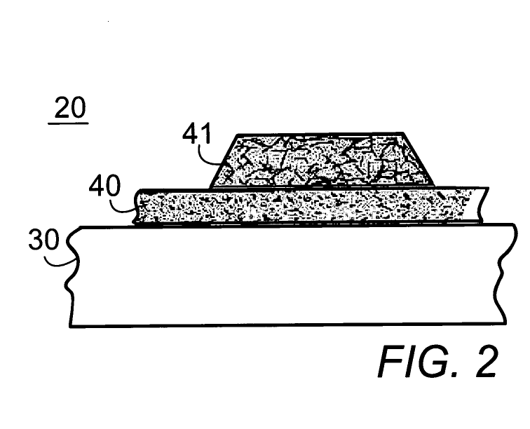

In FIGS. 1 and 2, a latently dispersible container barrier composite material 20 having a room temperature aqueous environment tensile peak load of 2000 grams or less comprises two primary layers. A barrier layer 30 of water insoluble composition contacts a moist waste material. A water sensitive layer 40 faces one side of the barrier layer 30. A water impermeable, inextensible, dispersible overlaid pattern layer 41 of support material is formed on the water sensitive layer 40 on a side facing away from the barrier layer 30 in situ in a composite fabrication process. The overlaid pattern layer 41 of support material is printed or sprayed and cured on the barrier layer by a VOC evaporation and oxygenation, UV radiation or other means for curing the overlaid pattern layer 41 of support material, the barrier layer 40 thereby interbonded and supported by the water sensitive layer 40 reinforced by the overlaid pattern layer 41 of support material.

The barrier layer 30 may comprise a film having a thickness less than fifty-five microns of a polymer used to waterproof, such as a wax or a polylactic acid.

The water sensitive layer 40 may comprise polyvinyl alcohol. The water sensitive layer 40 may further comprise modified ethylene vinyl acetate blended with the polyvinyl alcohol.

The latently dispersible container barrier composite material may have a hydrohead of at least 15 mbar and a wet tensile maximum load of about 1000 g. Other ranges for different applications include a hydrohead of at least 25 mbar, a hydrohead of at least 50 mbar and a water sensitive layer thickness within the range of from about 10 microns to about 1000 microns or a water sensitive layer thickness within the range of from about 10 microns to about 50 microns. The water sensitive layer 40 may comprise polyethylene oxide.

The printed support may have an extensibility of less than about 15%.

The barrier layer may comprise at least one polymer selected from the group of polymers including copolyesters, polycaprolactone, hydroxypropyl cellulose, polyvinyl pryidine, gelatinized starch, nylon copolymers, acrylic acid copolymers, waxes and blends of the foregoing.

In one embodiment the latently dispersible and biodegradable composite material 20 comprises a low strength barrier layer 30 having a thickness of less than about three microns or greater and coextruded with a water sensitive layer 40 comprising a blend of polyvinyl alcohol and modified ethylene vinyl acetate having a thickness within the range of from about 10 to about 100 microns, and a support layer 41 bonded to and facing the barrier layer 30 or water soluble layer 40, the support-reinforcement layer comprising a printed pattern of at least one non dispersible materials taken from the list of non dispersible materials including copolyesters, polyaprlactorne hydroxypropyl cellulose, polyvinyl pyridine, gelatinized starch, nylon copolymers, acrylic copolyments, waxes and blends and additions taken from the list of blends and additions including whiskers, crystals, filaments composed of polymers, ceramics or carbonaceous materials of the forgoing having an extensibility of less than about 35% and a basis weight in the range of from about 10 gsm to about 70 gsm, the composite having a hydrohead of at least about 10 mbar and CD wet tensile maximum load of less than about 2000 g.

One embodiment of the invention finds use as a dog waste disposable bag. One basic form of a disposable dog waste container is a “plastic bag”. A desirable implementation as a flushable bag which utilizes an impermeable substrate (“plastic bag”) which contains dog wastes, but which can be transferred from the commode and flushed down the toilet. Many other uses will be apparent to those of skill in the art, including, without limitation, emesis basin liners, pet excrement containers, bedpan liners, medical waste containers, colostomy bags, toilet seat liners, medical drapes and garments, hospital or nursing home bed liners, bandages. In other areas, beverage containers, agricultural tapes and seed fabrics as well as laundry and dishwashing detergent containers may be made from the composites of the present invention.

The composite of the invention is particularly useful for those applications necessitating a barrier to liquid flow in one direction but readily dispersible by liquid flow or contact in the opposite direction. One embodiment of the invention finds use as a waste containment bag, for example, a commode liner. A desirable implementation as a flushable commode liner utilizes an impermeable substrate (“plastic bag”) which contains biological wastes, but which can be transferred from the commode and flushed down the toilet. Other uses such as disposable beverage containers, bath mats, shower caps, and the like will be apparent to those skilled in the art.

The key features of the impermeable substrate in-use are a minimum level of integrity so the product can be handled in use, for example, the waste bag can be filled and transported for several minutes without bursting or stretching to the point of rupture, and a barrier function defined by the hydrohead values of at least about 15 mbar, about 25 mbar, about 50 mbar or about 75 mbar as appropriate to the intended use so the bag or product contains the waste over an extended period of time. The impermeable composite for many applications needs to have sufficient wet flexibility, so the product easily conforms and goes down the toilet, if flushed, and dispersibility, so the film is acceptable for septic or municipal sewage treatment systems.

A coextruded bilayer film coated onto or otherwise bonded to a stabilizing, inextensible but highly dispersible printed pattern, has been developed in accordance with the invention to manage the balance of in-use integrity (strength and barrier) and flushability (wet flexibility and dispersibility). The base layer in the film may be a water-soluble poly(vinyl alcohol) blend adhered to the printed support layer, with the printed support forming one exposed layer of the liner, while the second, exposed layer may be thin, low strength, fluid-impervious, preferably water insoluble and biodegradable layer, which lines the inside of the product in, for example, a container embodiment. The PVOH/printed support provide strength prior to disposal, so the product and contents can be carried to the toilet or other aqueous disposal area. In the toilet, the PVOH and tissue dissolve or disperse, leaving only the very thin barrier layer and the body or other type of waste to move down the toilet. The thin barrier layer must have enough impermeability to contain the waste when supported by the dry PVOH/printed support pattern layers; after clearing the toilet, the thin layer desirably will break up to avoid clogging in the pipes. The biodegradable nature of the barrier layer ensures a safe treatment and breakdown of the barrier remnants when they reach the wastewater treatment plant or septic system. It is also desired for certain applications that the barrier layer be maintained thin so as to avoid imparting excessive wet tensile properties to the composite of, for example, no more than 2000 g of wet tensile peak load and in some applications, no more than 1000 g. Examples of barrier film materials in addition to PLA include copolyesters such as Eastar Bio GP products from Eastman, polycaprolactone such as Tone P767 from Union Carbide Corporation, 39 Old Ridgebury Road, Danbury, Conn., a polybutylene succinate polymer or a polybutylene succinate-co-adipate polymer or a mixture of such polymers, polypropylene oxide, cold-water insoluble PVOH, polyvinyl alcohol copolymers, gelatinized starch, nylon copolymers, acrylic acid copolymers, other copolymers of and blends of any of the foregoing. For specific examples, reference is directed to WO 96/20831 to Larson et al., incorporated herein in its entirety by reference. Desirable applications will include a barrier layer thickness of up to 5 microns and, in many cases, up to only about 2 microns.

Various polymers can be used for the thin barrier layer component which, advantageously, is formed by coextrusion with the water sensitive, for example, PVOH, layer. As previously mentioned, PLA is ideally suited as a barrier layer, but other polymers may be used, such as polyolefins and the others previously identified. PLA and other biodegradable resins are preferred for environmental reasons.

The water sensitive layer of the present invention includes compositions of selectively water-responsive polymer blends. These water-responsive polymer blends may be constructed from water-soluble and hydrolytically degradable polymers including polyethylene oxide (PEO) and polyvinyl alcohol (PVOH)). Cold-water soluble polyvinyl alcohol (PVOH) of partially hydrolyzed polyvinyl acetate is desired for the compositions of the present invention and typically the hydrolysis level is between approximately 70% and 85%. The term “hydrolysis level” as used herein, is defined as the percentage of vinyl acetate units in polyvinyl acetate which are hydrolyzed into vinyl alcohol units in the polyvinyl alcohol. Depending upon the purpose and use of an article, compositions comprising different components of variable water sensitivity may be desired. Controlling water-responsiveness is necessary for different components in certain products due to the location of use in relation to body or other waste. The thickness of the water responsive layer will depend on the desired use and will frequently be in the range of from about 10 microns to about 50 microns and, for some applications, in the range of from about 15 microns to about 45 microns.

Generally, manufacturers of polymers utilizing standard processes convert raw material monomers into polymer beads, resins or other pelletized or powdered products, which are commercially available from companies such as Aldrich (Milwaukee, Wis.), Dow Chemical (Midland, Mich.), DuPont Company (Wilmington, Del.), Exxon (Baytown, Tex.), Nippon Goshei (Japan) and Union Carbide Corporation (Danbury, Conn.). The polymer in this form may then be used in processes such as extruding blow-molding, casting films, blowing films, thermoforming, injection molding or fiber spinning at elevated temperatures, for example, to form useful articles. The above processes are collectively referred to as melt processing. Polymers produced by processes that are to be provided commercially as beads, resins powders or other non-finished solid forms are generally referred to collectively as polymer resins.

PLA resins produced by different synthetic methods such as ring-opening polymerization of lactide or direct condensation polymerization from lactic acid are particularly useful for the compositions used for the thin film component in the present invention. PLA (MW=133,900, Viscosity at 1000 (1/s) of 331, melt temperature 169.degree. C., relative viscosity 2-8-3.4 and % D less than or equal to 1.4) purchased from Cargill-Dow as Grade 6200D, may be used, for example. Also exemplary types of resins include various grades from Cargill, Incorporated as are described in WO 98/50611, incorporated herein by reference in its entirety. In addition, thin barrier meltblown layers are contemplated as are also described in WO 98/50611. As stated, the barrier layer, depending on the polymer and use, may have a thickness of about 2 microns or below for economy and ease of disposal. Cold water dispersible PVOH (Gohsenol KP08, KP06, and KP05, purchased from Nippon Gohsei, Japan) are also an exemplary of types of useful resins as are various grades of Evanol 40-05 PVOH from duPont, Wilmington, Del.

The barrier and water-sensitive polymer film compositions according to the present invention are desirably produced by a melt layering process. It is desired according to the present invention to coextrude the two components in an extruder, such as a single-screw or twin-screw extruder under appropriate temperature and shear/pressure conditions to ensure bonding. Useful processes are described, for example, in coassigned U.S. Pat. Nos. 6,075,179 to McCormack and Hetzler issued Jun. 13, 2000 and 6,114,024 to Forte issued Sep. 5, 2000, each incorporated herein by reference in its entirety. The process can also be performed in a batchwise device, such as a melt mixer or a kneader. PLA or PVOH can be fed into the coextruder either in a single or multimanifold die configuration.

The preferred water sensitive layer is a film of PVOH. The present invention also contemplates as the water sensitive layer layers of selectively water-responsive homogeneous polymer blend compositions comprising a water sensitive polymer blend such as PVOH and anhydride-modified ethylene vinyl acetate available, for example, from duPont under the trademark BYNEL® for modulus reduction. The term “homogeneous polymer blend composition”, as used herein, means that the polymer blend forms a cohesive, continuous structure of anhydride-modified ethylene vinyl acetate and polyvinyl alcohol. A homogeneous polymer blend composition can be achieved by the mixing of polyvinyl alcohol and modified EVA at temperatures above the melting point of the polymer having the highest melting point, and below the decomposition point of the polymer having the lowest decomposition point, in order to form a homogeneous molten mixture of the polymers (prior to cooling to solid form, e.g. films or fibers). For homogeneous polymer blend compositions of modified EVA and polyvinyl alcohol, the polymer having the higher melting point is polyvinyl alcohol and the polymer having the lower decomposition point is also polyvinyl alcohol. The melting point for polyvinyl alcohol is generally approximately between 180-190.degree. C., and more specifically around 183.degree. C. The decomposition point of polyvinyl alcohol is above approximately 200.degree. C. The resulting composition resembles islands of modified EVA in a sea of polyvinyl alcohol, for example, and at a microscopic level has the appearance of approximately uniform distribution of modified EVA in polyvinyl alcohol. The homogeneous polymer blend composition of the present invention therefore has very fine dispersion of modified EVA within polyvinyl alcohol. The homogeneous polymer blend composition, therefore, is formed prior to the polymers being formed into films or nonwovens, resulting in compositions of polymers which are highly, and intimately interconnected, having a selectively uniform dispersion. Such compositions are distinguishable from those comprising blended polymers that consist of polymers which are blended after they have been formed into fibers or films, resulting in compositions which do not have approximate uniform dispersion and often appearing as individual polymers layered or mixed together. Summarily, when individual polymers are mixed at temperatures above the melting point of the polymer having the highest melting point, and below the decomposition point of the polymer having the lowest decomposition point, an approximately uniform distribution and dispersion of polymers results. In contrast, when individual polymers are mixed according to standard practices, a blended polymer composition results wherein the polymers are not as integrally associated. The water-sensitivity of the polymer compositions may be controlled according to the degree of the homogeneity of the polymer blends.

One embodiment of a water sensitive layer useful in accordance with the present invention is a homogeneous polymer blend composition comprising approximately 1-35% modified EVA and approximately 65-99% polyvinyl alcohol, wherein such composition is water-dispersible.

The compositions described may be formed into polymer films with printed reinforcement patterns cured by uv light or evaporation of volatile solvent or water can be used to achieve sufficient strength for the composite multilayer material. The printed pattern provides support for the barrier layer allowing it to thin enough to not be self supporting after the water soluble layer has dissolved.

Requirements for the printed pattern support-reinforcement layer are that it provide sufficient strength and stability for the intended use and that it disperse or dissolve in contact with aqueous liquid or otherwise allow water to permeate to the water sensitive layer. For applications such as commode liners or beverage containers, for example, it is important that the layer be relatively inextensible because stretching or sagging leads to fracture of the barrier layer and may result in leakage of the contents. In this regard, extensibility of the layer is desirably less than about 15% as measured by tensile testing and even more desirably less than about 12% or, for some applications, less than about 10%. This support-reinforcement also desirably will have a modulus in the range of greater than about 10 as measured by max slope as described above and for some applications in the range of greater than 15 or for others greater than 20. Suitable support-reinforcement printed pattern layers are formed from the liquid polymer with reinforcement media or ink having a basis weight in the range of from about 10 to about 75 gsm, for example. The combination with the barrier layer and water sensitive layer is desirably produced by coextrusion of a bilayer film. The printed support-reinforcement pattern is cured by evaporation of VOC, UV thermal or other means consistent with obtaining the desired properties of the printed pattern described. For many applications it is desirable for the barrier layer to be as thin as is practical consistent with manufacturing and functionality. For example a PLA film of thickness in the range of from about 0.5 micron to about 2 microns may be coextruded with a PVOH film having a thickness in the range of from about 10 microns to about 100 microns. For cost savings the total thickness is desirably within the range of from about 25 to about 75 microns for many applications. As will be appreciated, thicknesses may vary outside those ranges for certain applications. Desirably, the coextruded film is printed on directly with the reinforced ink applied directly to the water insoluable layer.

Barrier layers include films or fine fibers of very lightweight construction using polymers such as polylactic acid or polycaprolactone. Examples of water sensitive carrier webs include films of polyvinyl alcohol with or without other components. Examples of inextensible support materials include higher modulus or low printed patterns of printable polymers containing solid reinforcements selected from the group consisting of copolyesters, polycaprolactone, hydroxypropyl cellulose, polyvinyl pryidine, gelatinized starch, nylon copolymers, acrylic acid copolymers, waxes and blends of the foregoing. This printed web or network overprinted on the insoluble surface provides tensile strength and stiffness to prevent the thin insoluble layer from failing until water soluble layer on the other side of the composite membrane dissolves when flushed. This network of reinforcement composed of non soluble printable curable polymers is overprinted with a pattern of a flexible arranged with a predetermined spacing. The pattern of the printed reinforcement is arranged to un-link when the water soluble layer supporting it is dissolved, producing a discontinues dispersable mass of small segments which are easily flushed.

### Test Procedures

Tensile: shapes weighing 25 grams when wet.
Hydrohead: A measure of the liquid barrier properties of a fabric is the hydrohead test.

The hydrohead test determines the millibars of water pressure that the fabric will support before a predetermined amount of liquid passes through. A fabric with a higher hydrohead reading indicates it has a greater barrier to liquid penetration than a fabric with a lower hydrohead. The hydrohead test is performed according to Federal Test Standard 191A, Method 5514 except that no support was used, and the measure was taken at the first drop of penetration.

### Flushability Testing

### Materials

A 4 inch square piece of the composite material is immersed for a period of 60, and 120 and 300 seconds in the water filled room temperature toilet bowl containing 1.5 gallons of tap water, which contains a barrier across its exit tube of wire mesh. After the selected time period the toilet is flushed and the non dispersed material is retained on the screen for examination.

### Procedure

A 4 inch square piece of the composite material is immersed for a period of 60, and 120 and 300 seconds in the water filled room temperature toilet bowl containing 1.5 gallons of tap water, which contains a barrier across its exit tube of 1.0 inch opening wire mesh. After the selected time period the toilet is flushed and the non dispersed material is retained on the screen for examination.

Observe that the composite material passes through the screen barrier system and does not become clogged.

### Pass Criteria

The composite is considered flushable if the composite passes through the screen in 4 flushes or less, nine out of ten times. The composites must also pass through screen on repeated flushings without clogging. The composite need not pass through the screen in only 2 flushes but must show continued dissolution and disinitegration with each flush, and eventually pass entirely out of the toilet and down the sewer pipe.

### Dispersibility

Composite bag samples were placed in a domestic washing machine and then observed as they were put through a standard cold wash cycle using only tap water. The washing machine produces hydraulic flow rates estimated at of about 1.5 feet per second, which are comparable to observable general conditions seen in travel through the sewer line to a sewage treatment plant. After 15 minutes the simulator was drained of water through a screened outlet with a centrifugal electric pump, and any coherent sections of the test articles are caught on the screen were recovered. These sections were then measured to determine their total mass. The total area of a composite sample is 4 inches square and it is considered dispersed if no more than about 40%, desirably no more than about 25%, and more desirably no more than about 15% of the original barrier layer is discernable as a coherent mass.

### Materials

Standard 4 inch square
Domestic washing machine as described above.
Stop watch

### Screen

Pump and tubing

### Procedure

1. Fill washing machine to the load line
2. Start the machine and timers
3. Start agitation cycle
4. Drop sample into washing machine
5. Allow machine to run for 120, 300, 600 seconds
6. Turn off agitator
7. Allow contents to settle
8. Turn off washing machine
9. Remove undissolved sections of composite that are visible or floating. Be careful not to damage the sections and keep them separate from one another to avoid sticking.
10. Drain out water using the pump with a fine (0.1 mesh) screen to catch the pumped material prior to entering the pump.
12. Unravel and dry all retained composite pieces and filtrate
13. Record areas of composite pieces and mass based on area determination and multiplying by pre-weight basis weight.

It is understood that the preceding description is given merely by way of illustration and not in limitation of the invention and that various modifications may be made thereto without departing from the spirit of the invention as claimed.

What is claimed is:

1. A latently dispersible container barrier composite material having a room temperature aqueous environment tensile peak load of 2000 grams or less comprising:
a. a barrier layer of water insoluble composition;
b. a water sensitive layer facing one side of the barrier layer; and
c. a water impermeable, inextensible, dispersible overlaid pattern layer of support material formed on the water sensitive layer on a side facing away from the barrier layer in situ in a composite fabrication process, the overlaid pattern layer of support material cured on the barrier layer by a means for curing the overlaid pattern layer of support material, the barrier layer thereby interbonded and supported by the water sensitive layer reinforced by the overlaid pattern layer of support material.

2. The latently dispersible container barrier composite material of claim 1 wherein the water impermeable, inextensible, dispersible overlaid pattern layer of support material comprises a printed material.

3. The latently dispersible container barrier composite material of claim 1 wherein the water impermeable, inextensible, dispersible overlaid pattern layer of support material comprises a sprayed on material.

4. The latently dispersible container barrier composite material of claim 1 wherein the means for curing the overlaid pattern layer of support material comprises VOC evaporation and oxygenation.

5. The latently dispersible container barrier composite material of claim 1 wherein the means for curing the overlaid pattern layer of support material comprises UV radiation.

6. The latently dispersible container barrier composite material of claim 1 wherein the barrier layer comprises a film having a thickness less than fifty-five microns.

7. The latently dispersible container barrier composite material of claim 1 wherein the barrier layer comprises a polymer used to waterproof.

8. The latently dispersible container barrier composite material of claim 7 wherein the polymer used to waterproof comprises a wax.

9. The latently dispersible container barrier composite material of claim 7 wherein the polymer used to waterproof comprises a polylactic acid.

10. The latently dispersible container barrier composite material of claim 1 wherein the water sensitive layer comprises polyvinyl alcohol.

11. The latently dispersible container barrier composite material of claim 10 wherein the water sensitive layer further comprises modified ethylene vinyl acetate blended with the polyvinyl alcohol.

12. The latently dispersible container barrier composite material of claim 1 having a hydrohead of at least 15 mbar.

13. The latently dispersible container barrier composite material of claim 12 having a wet tensile maximum load of about 1000 g.

14. The latently dispersible container barrier composite material of claim 1 having a hydrohead of at least 25 mbar.

15. The latently dispersible container barrier composite material of claim 1 having a hydrohead of at least 50 mbar.

16. The latently dispersible container barrier composite material of claim 15 having a water sensitive layer thickness within the range of from about 10 microns to about 1000 microns.

17. The latently dispersible container barrier composite material of claim 15 having a water sensitive layer thickness within the range of from about 10 microns to about 50 microns.

18. The latently dispersible container barrier composite material of claim 15 wherein the printed support has an extensibility of less than about 15%.

19. The latently dispersible container barrier composite material of claim 1 wherein the water sensitive layer comprises polyethylene oxide.

20. The latently dispersible container barrier composite material of claim 1 wherein the barrier layer comprises at least one polymer selected from the group of polymers including copolyesters, polycaprolactone, hydroxypropyl cellulose, polyvinyl pryidine, gelatinized starch, nylon copolymers, acrylic acid copolymers, waxes and blends of the foregoing.

21. A latently dispersible and biodegradable composite material comprising:
a. a low strength barrier layer having a thickness of less than about three microns or greater and coextruded with,
b. a water sensitive layer comprising a blend of polyvinyl alcohol and modified ethylene vinyl acetate having a thickness within the range of from about 10 to about 100 microns, and
c. a support layer bonded to and facing said barrier layer or water soluble layer, said support-reinforcement layer comprising a printed pattern of at least one non dispersible materials taken from the list of non dispersible materials including copolyesters, polyaprlactorne hydroxypropyl cellulose, polyvinyl pyridine, gelatinized starch, nylon copolymers, acrylic copolyments, waxes and blends and additions taken from the list of blends and additions including whiskers, crystals, filaments composed of polymers, ceramics or carbonaceous materials of the forgoing having an extensibility of less than about 35% and a basis weight in the range of from about 10 gsm to about 70 gsm, the composite having a hydrohead of at least about 10 mbar and CD wet tensile maximum load of less than about 2000 g.
